(19) United States
(12) Patent Application Publication
(10) Pub. No.: US 2012/0329025 A1
(43) Pub. Date: Dec. 27, 2012

(54) METHODS FOR RECORDING AND DETERMINING A CHILD'S DEVELOPMENTAL SITUATION THROUGH USE OF A SOFTWARE APPLICATION FOR MOBILE DEVICES

(75) Inventor: Dan Dan Yang, Ottawa (CA)

(73) Assignee: RULLINGNET CORPORATION LIMITED, Hong Kong (HK)

(21) Appl. No.: 13/164,982

(22) Filed: Jun. 21, 2011

(51) Int. Cl. G09B 5/00

(52) U.S. Cl. 434/322

(57) ABSTRACT

Systems and methods for measuring and improving a young child's mental abilities on a tablet computer. A user of the tablet computer is prompted for the child's age and, based on the age, the expected performance or abilities of the child are provided. The child can be assessed using a number of activities whereby the child identifies and/or matches various objects. The assessment can be done by timing the activity to completion, determining how many errors/tries were needed to complete the activity, or any other number of assessment techniques. The child's performance is then compared against expected metrics for children of a similar age. The activities can range from games that involve identifying everyday objects to the introduction of mathematical concepts and numbers to identifying and/or matching animals.

### TECHNICAL FIELD

The present invention relates to the tracking of a child's development. More specifically, the present invention relates to methods, systems, and devices for assessing a child's mental and physical development.

### BACKGROUND OF THE INVENTION

Child development has been scientifically measured for decades and parents have been trying to get their children to have an early start in mental, physical, and social development for longer than that. Whether it is through buying “smart” toys or having them tutored at a young age or enrolling them into sports programs at a young age, ambitious parents have wanted their children to be above average in physical ability and mental acuity. Some parents merely want to be able to see their children grow up as a well-rounded individual. However, whether parents want their children to be the next Albert Einstein or just to be well-rounded, there does not exist simple means for determining if a young child, especially a very young child, is mentally or physically meeting the norm for children of similar age.

Professional psychologists or educators have access to assessments which can measure how a young child develops. Such assessments typically cost hundreds of dollars and are not easily accessible to parents. Often, the assessment is suggested when parents suspect a developmental delay.

It would be useful for such assessments, or a portion of such assessments, easily accessible and simple enough to use so that each child can be checked against age norms. Not only can possible developmental delays be found earlier but parents can use such a tool to identify a child's strengths and weaknesses in order to help their child to improve and develop into a well rounded grownup.

There is therefore a need for methods and systems which mitigate if not overcome the shortcomings of the prior art.

### SUMMARY OF INVENTION

The present invention provides systems and methods for measuring a young child's mental and physical abilities on a mobile device, such as a smartphone or a tablet PC, to compare that child's abilities with norms for children of a similar age. A user of the mobile device is prompted for the child's age and, based on the age, the expected performance or abilities of the child are provided. Some of the child's abilities can be assessed using a number of activities whereby the child identifies and/or matches various objects using the mobile device. The child's physical abilities (e.g. motor skills) can be assessed by providing the user with instructions on physical activities that the child can perform and how these abilities can be measured using these activities. As examples, the assessment can be done by timing the activity, whether the activity uses the mobile device or is based on instructions from the mobile device. Other methods of assessment, such as determining how many errors/tries were needed to complete the activity, or any other number of assessment techniques may be used. Once the results have been entered into the software application, the child's performance is then compared against expected metrics for children of a similar age. The user can thus determine if the child's abilities are within the expected ranges for children of a similar age. The mobile device based activities can range from games that involve identifying everyday objects to the introduction of mathematical concepts and numbers to identifying and/or matching animals.

In a first aspect, the present invention provides a method for assessing a child's developmental progress, the method comprising:

a) determining said child's age;

b) providing a user with expected capabilities for a similar child of similar age;

c) providing said user with a plurality of activities for said child, said activities being for assessing said child's abilities;

d) receiving results of at least one of said plurality of activities;

e) comparing said results of said at least one of said plurality of activities with said expected capabilities for a similar child of similar age;

wherein said method is executed on a mobile computing device.

In a second aspect, the present invention provides computer readable media having encoded thereon computer readable instructions which, when executed, executes a method for assessing a child's developmental progress, the method comprising:

a) determining said child's age;

b) providing a user with expected capabilities for a similar child of similar age;

c) providing said user with a plurality of activities for said child, said activities being for assessing said child's abilities;

d) receiving results of at least one of said plurality of activities;

e) comparing said results of said at least one of said plurality of activities with said expected capabilities for a similar child of similar age;

wherein said method is executed on a mobile computing device.

### BRIEF DESCRIPTION OF THE DRAWINGS

The embodiments of the present invention will now be described by reference to the following figures, in which identical reference numerals in different figures indicate identical elements and in which:

FIG. 1 is a front view of a tablet computer on which the present invention may be practiced;

FIG. 2 is an example screenshot of a table presented to the user detailing expected abilities of differently aged children;

FIGS. 3-9 illustrate different activities which may be used in one aspect of the invention;

FIG. 10 is a flowchart detailing logic flow according to one aspect of the invention.

### DETAILED DESCRIPTION OF THE INVENTION

The following description and attached diagrams are provided as examples of possible configurations and functionalities of software which fall under the scope of the present invention. They are not to be taken as in any way limiting the scope of the present invention.

The present invention provides methods and systems for use with mobile computing devices such as tablet computers and smartphones. The user, preferably an adult, is prompted for the child's age. Once this has been entered, a chart or entry provides the user with expected/average capabilities of a child of a similar age. The entry gives indications of a similarly aged average child's capabilities such as to how long such a child should take to accomplish tasks, what the child should be able to recognize in terms of animals, numbers, letters, items, musical concepts, etc. The entry also gives indications as to the similarly aged child's capabilities with respect to physical abilities (e.g. motor skills). As well, a listing of activities available on the mobile computing device or through the mobile computing device for the child is presented. Each activity is also indexed with capabilities or abilities that the activity is designed to assess. The user can thus assess a child's mental or cognitive abilities by launching a specific activity on the mobile computing device and by having the child pursue that activity. For the child's physical abilities, the mobile computing device can provide instructions to the user regarding activities which the child can participate in and which can be used to assess these abilities. The user can thus follow the devices's instructions and assess specific aspects of the child's physical abilities.

For the mental and cognitive ability assessment, the mobile computing device may determine how long it takes to complete the device based activity or how many tries/errors were committed. Alternatively, the mobile computing device may use any number of metric-based measurement methods which determine the child's performance.

To measure the child's physical abilities, based on instructions from the mobile computing device, the user may time the child's specific activities, measure physical distances involved in the activity, or use other measurement aspects as may be appropriate.

Once the data regarding the child's activities have been gathered, these may be entered into the mobile computing device as necessary. Of course, if the activities are performed through the mobile computing device, there may be no need to enter the results as these results can be automatically catalogued in the device.

The different activities can be used to provide a preliminary assessment of the child's motor skills, social/emotional skills, language skills, or cognitive skills. As noted above, such a preliminary assessment can be carried out to determine if a more involved assessment of the child's abilities is warranted. The results of the preliminary assessment can be displayed to the user in association with developmental norms for similarly aged children. A user can thus determine, by comparing the norms with the results of the preliminary assessment, whether a professional assessment is required.

The skills and abilities which may be assessed are motor skills, social/emotional skills, language skills, and cognitive skills.

Motor skills relate to the physical movement of the body and a child's ability to control these movements. Motor skills are generally divided into two types: gross motor (such as whole body, large muscle movements) and, fine motor (hands, and hand-eye coordination).

Social/Emotional skills relate to a child's ability to conduct themselves in social situations and to manage their internal emotions.

Language skills, including listening comprehension, vocabulary and speaking, are critical for literacy development and the child's ability to communicate needs, wants and ideas to others. Consistent exposure to and involvement in conversations, following verbal instructions, targeted vocabulary learning, and encouragement to speak all contribute to the development of language skills.

Cognitive skills relate to what a child knows and understands. It includes both general knowledge (for example colors, shapes, objects) and also abstract knowledge such as spatial reasoning, pattern recognition and cause and effect relationships. In most cases, the ability to integrate knowledge and develop conceptual understanding can only be learned through exploration and sensory experience. Providing young children with frequent, wide-ranging opportunities to explore and experience the world around them fosters the development of cognitive skills.

It should be noted that the present invention is not meant as a replacement for a complete, formal, and scientific assessment of the child's abilities and capabilities. The invention is meant as an informal, rough, and preliminary, yet useful, assessment of the child's abilities which can be administered by a child's parent. The invention is not meant to completely assess the child's abilities. The present invention can assess some of the more general abilities of the child and can give results which can be used to determine whether further, more exhaustive and more formal study and/or assessment is warranted. As an example, if the adult administering one of the activities determines that, based on the data provided by the mobile computing device and the results from the child, the child is below or well below the expected norms for at least one particular ability or development, the adult may decide to have the child assessed by properly trained and accredited psychologists.

While the present invention does not seek to replace the more formal and thorough professional assessment of the child's abilities, it does have advantages over this more complete yet inconvenient professional assessment. Specifically, the present invention is more convenient and more inexpensive than the professional assessment. Parents can administer the assessment at any time and the high fees charged by the professional child psychologists are generally avoided. The preliminary assessment of the child's abilities is sufficient, in most cases, for determining the child's overall physical and psychological development. Of course, if the mobile device based assessment indicates that the child is not developing in line with other children of a similar age, the parent or user may opt for the professional psychologist's assessment.

Another advantage that the present invention has is its ability to remind parents/users to administer the assessment. As will be explained in more detail below, reminders may be programmed into the software to remind the user/parent to administer the assessment. The reminders can be monthly, quarterly, or yearly in frequency. The use of such a reminder system ensures that a regular and inexpensive assessment of the child's development is performed.

The present invention also provides for the user to create and maintain an album or collection of multimedia files detailing the child's growth and development. As the mobile computing device, such as a tablet computer, preferably is equipped with a camera and a microphone with the capability to take still photographs or full motion (preferably with sound) video, the user can take video and/or photographs of the child as the child grows up. These files can then be tagged with notes from the user. The device may also prompt the user to take such photos or video at specific times in the child's development to ensure that the album is updated. The results from the assessments of the child's abilities can also be incorporated into the album. These results can be associated with the age of the child at which the child's abilities were assessed.

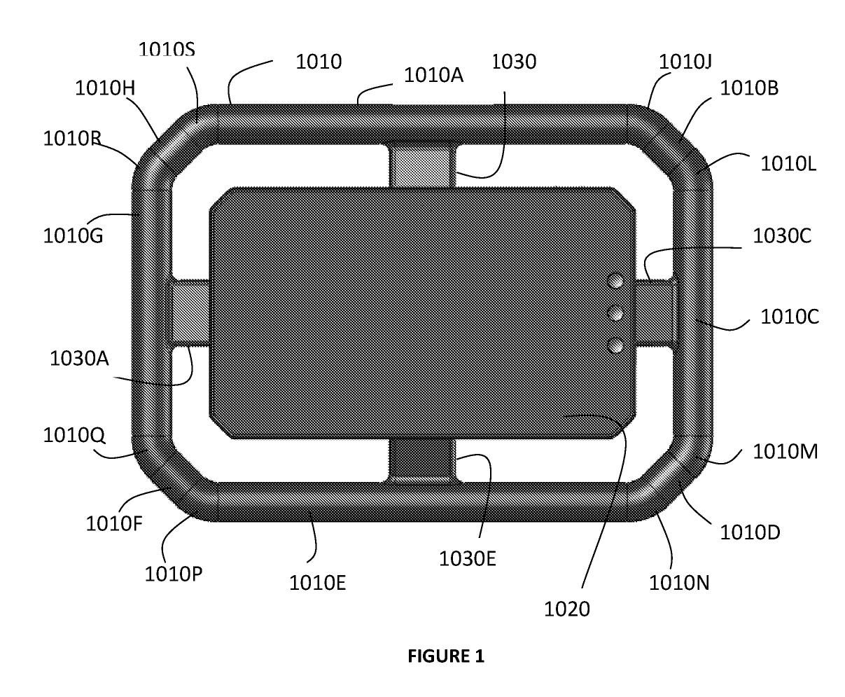

Referring to FIG. 1, a front view of a sample mobile computing device, in this case a tablet computer, on which the invention may be practiced is illustrated. The front elevation view shows a touch screen capable tablet computing device 20 which executes methods according to one embodiment of the present invention. Preferably, as shown, the tablet computer is provided with a handle suitable for use by young or even child users. Illustrated in FIG. 1 is a preferred exemplary embodiment of the tablet computer. The handle 1010 is affixed to the tablet computing device 30 through 4 bridging pieces 1030A, 1030B, 1030C, 1030D. The front view of FIG. 1 shows the touch screen of the computing device 1020. As shown in FIG. 1, the handle 1010 has an octagonal shape with eight (8) edges, 1010A, 1010B, 1010C, 1010D, 1010E, 1010F, 1010G, and 1010H. Each pair of adjacent edges meets at rounded edges 1010J, 1010L, 1010M, 1010N, 1010P, 1010Q, 1010R, and 10105. As shown, the four bridging pieces 1030A, 1030B, 1030C, 1030D affix the handle 1010 to the computing device 1020, such that there are four corresponding spaces between the handle and the computing device, to enable the infant to grasp the handle and to simultaneously be able to manipulate the touch screen.

Given that young children will be using the mobile computing device and its software, such young children will, of course, have special needs that the software applications will need to address. As an example, these child users may not be completely able to use and/or manipulate regular I/O interfaces such as keyboards and mice. These child users will, however, be able to use touch screen interfaces and it is these interfaces that will be the preferred interface for such software.

Another possible special need for child users is their limited visual acuity. As such, such software would need large, easily visible icons and visual cues and indicia so that they may be easily seen and perceived by the child users.

It should be noted that ease of use of the software for the child users, such as the large icons and other visual indicia and the touch screen interface, are not the only preferable features of the software. The activities presented by the software should also be very simple, easy to understand, and accessible to the child users. As such, activities such as color matching, identifying and matching simpler shapes, images, and icons would be ideal for the child user using the software. Also, simple musical matching, musical instrument identification, and possibly simple musical instrument simulation may be presented to the child user.

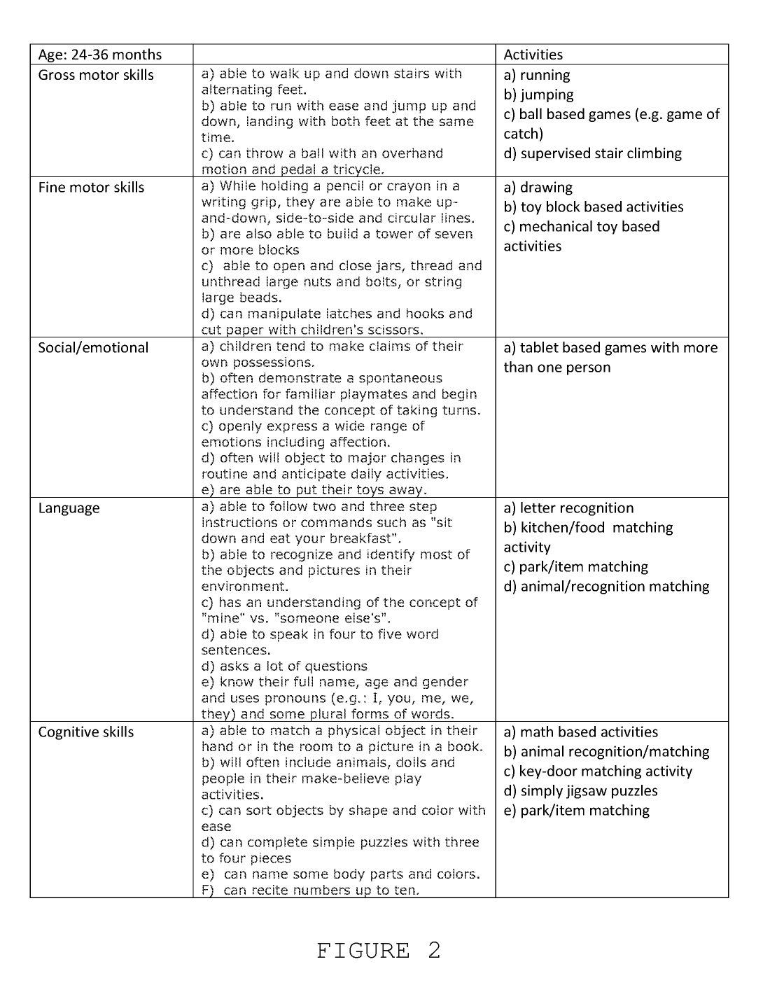

Referring to FIG. 2, an exemplary screen shot of a chart detailing the expected abilities of children of various ages is illustrated. Tables I and II below are also provided to illustrate the different areas of abilities and activities available to children of various ages. As can be seen from the figure and from the tables, different age groups (the age groups ranging from a few months old to about 4 years old) have different abilities. A number of activities are listed for each of the various abilities or capabilities. These activities are those to be used for measuring or assessing these abilities in young users. It should be noted that some activities relate to multiple abilities. These activities can therefore be used to measure multiple abilities. Other examples of such tables are provided in the tables below. It should be noted that the content of these tables are based on research from child experts including well-known child psychologists and researchers. Such data can easily be found in the literature by those skilled in the art and may be different depending on the sources used. One possible source of such data is the book “Caring for Your Baby and Young Child: Birth to Age 5” written for the American Academy of Pediatrics and edited by Steven P. Shelov. Other sources may, of course, be used.

TABLE 1

| Age: 13-18 | | Activities For |
|---|---|---|
| Months | | Assessment |
| Gross Motor | During this stage, children | a) Safely climb |
| | are typically able to climb | chairs |
| | into chairs without | b) independent |
| | assistance. They begin to | walking |
| | walk independently and are | |
| | able to climb stairs in a | |
| | standing position with the | |
| | help of an adult. | |
| Fine Motor | During this stage, children | a) play with |
| | are able to construct a | blocks |
| | three-block tower. They can | b) utensil usage |
| | use a spoon well and drink | c) manipulate |
| | easily from a cup. Children | book |
| | at this age can flip the | d) manipulate |
| | pages of a board-style book, | container |
| | often a few pages at a time. | |
| | They are also able to turn | |
| | over a container and pour | |
| | out the contents. | |
| Social/Emotional | During this stage, children | a) knowledge of |
| | are often able to remove | and placement of |
| | some of their clothing on | body parts |
| | their own. They can point to | b) knowledge of |
| | body parts and other | common tasks and |
| | familiar objects when asked. | items |
| | They are also capable of | |
| | helping out with simple | |
| | tasks. | |
| Language | During this stage, many | a) |
| | children have a five to ten | identification |
| | word vocabulary and are able | of common items |
| | to follow a simple | b) |
| | instruction. | identification |
| | | of body parts |
| Cognitive | During this stage, children | a) hide and seek |
| | are able to find objects | with items |
| | hidden under two or three | b) |
| | layers or coverings. They | identification |
| | are also able to use objects | of common items |
| | as tools. | |

TABLE II

| | | Activities for |
|---|---|---|
| Age: 36-48 months | | assessment |
| Gross motor | During this stage, children | a) Hopping on |
| | are usually able to both | one foot |
| | hop and stand on one foot | b) Ball kicking |
| | for up to four seconds. | c) Catching |
| | They can kick a ball | bouncing ball |
| | forward and are able to | |
| | catch a ball bounced to | |
| | them. | |
| Fine motor | During this stage, children | a) drawing |
| | are often able to draw a | (with or |
| | person with two to four | without tablet) |
| | body parts. They can draw | b) manipulation |
| | circles and squares. At | of tools (e.g. |
| | this age, they can use | scissors) |
| | children's scissors to cut | |
| | paper. They have the hand | |
| | control to twiddle their | |
| | thumbs or perform a finger- | |
| | to-thumb sequence such as | |
| | that used in the Itsy-Bitsy | |
| | Spider song. | |
| Social/Emotional | During this stage, children | a) Providing |
| | tend to look forward to new | example |
| | experiences. They cooperate | conflicts and |
| | with other children. They | having the |
| | win often. engage in role- | child assess |
| | playing. At this age, | the situation |
| | children can be inventive | b) Role-playing |
| | and are capable of | with the child |
| | negotiating solutions to | |
| | conflicts. Children begin | |
| | to view themselves as a | |
| | whole person. that includes | |
| | a body, a mind and | |
| | feelings, but they often | |
| | cannot distinguish fantasy | |
| | from reality. | |
| Language | During this stage, children | a) Tablet based |
| | demonstrate an | audio |
| | understanding of the | activities |
| | concepts of “same” and | b) Recording |
| | “different”. Most children | audio stories |
| | at this age have mastered | from the child |
| | the basic rules of grammar. | c) enunciated |
| | They speak in sentences of | speech |
| | five to six words. They can | |
| | tell stories and speak | |
| | clearly enough for | |
| | strangers to understand. | |
| Cognitive | During this stage, most | a) Tablet based |
| | children can correctly name | recognition of |
| | some colors and understand | colors |
| | the purpose of counting. | b) tablet based |
| | They begin to have a | color matching |
| | clearer sense of time. They | c) math based |
| | are capable of knowing. | activities |
| | their home address. At this | |
| | age, children are able to | |
| | follow three-step | |
| | instructions. They can | |
| | recall parts of a story and | |
| | invent and tell simple | |
| | stories. They enjoy | |
| | creating a rich fantasy | |
| | world. | |

To measure one of the abilities (e.g. an ability relating to mathematical concepts), the user selects the relevant ability and, when the list of available activities relating to that activity is presented, the user selects one of the available activities.

If the ability is a physical one (e.g. motor skills), the user is provided with instructions on the activity as well as how to assess the child's ability. Where necessary, the user is provided with prompts to enter the results of the ability assessment.

If the ability is a cognitive/mental one, the activity selected launches on the mobile computing device and the child can partake of the activity. The mobile computing device can then automatically assess the child's ability as will be discussed below.

To assess the child's abilities, his or her performance in at least one activity needs to be measured. For the mobile device-based activities, the child user's performance can be measured by timing the activity session until a predetermined action occurs. This predetermined action may take the form of completing the activity or completing a predetermined portion of the activity (e.g. finishing 25%-50% of the tasks in the activity). Alternatively, the child's performance can be measured by determining how much of the tasks have been completed by a given time frame (e.g. how many matches between items have been made in 5 minutes). Task completion depends on whether the child's input is a desirable input or is an undesirable input. Desirable inputs contribute towards the completion of the activity while undesirable inputs can either have no effect or can be used to provide the child with another chance for a desirable input. It should be noted that it is preferable for the measurement of the child's performance to occur in the background, i.e. without the child being alerted to the measurement. The results of each activity session that measures the child's performance can be stored on the tablet computer and can be tagged with a date and time along with the child's calculated age. Depending on the implementation, a comparison of the child's performance relative to a predetermined mean or average may also be provided.

To assess the child's physical abilities (e.g. motor skills), the mobile computing device provides the user with detailed instructions for at least one physical activity along with instructions on how to assess the child's performance. As an example, one activity for older children (i.e. older than 2 years old) is a standing long jump. The mobile computing device provides instructions to the user to instruct the child to stand with both feet together and to jump forward as far as he or she can. The user is then instructed to measure the distance jumped by the child. The mobile computing device then prompts the user to enter these results. Other physical activities may be assessed by timing the activity (e.g. how long it takes the child to finish the activity) or measuring distances (e.g. how far the child can jump). Other measuring methodologies can also be used, depending on the implementation of the system. The physical activities may be based on running, jumping, and other physical acts that regular children normally perform.

It should be noted that, other than physical and mental abilities, the child's social abilities may also be tracked. When entering the child's assessment results, the user may be prompted to enter the child's social development. Since social development is not necessarily quantifiable, the system may present the user with a questionnaire with specific questions regarding the child's social interactions, reactions, and attitudes. The questionnaire may take the form of a multiple choice to ensure ease of use and to ensure that the data regarding the child's social abilities is properly entered.

The album functionality according to another aspect of the invention may work with the system described above. Results from the assessing the child's abilities may be saved in the album for the child to thereby track the child's physical and mental development. The results may be tagged or categorized with the child's age when the measurement was taken so that the child's mental, physical, and social progress may be tracked if desired. When prompting the user to enter the results of assessments of the child's physical abilities, the user may be prompted to determine if a digital image (or video) of the child is desired (i.e. does the user want a picture of the child as he or she is performing the activity?).

The album functionality according to another aspect of the invention provides the user with the opportunity to document the child's growth through digital media. If the user enters the child's birthdate into the tablet computer, the system can track the child's age. In doing this, the system periodically prompts the user to take a full motion video clip or a still digital photograph of the child at least once a year. The system can then either provide a suitable tag to the video or photograph identifying the child's age when the video or photograph was taken or the user can provide his or her own caption. Similarly, the user can take numerous video clips and/or numerous digital photographs of the child and the system can prompt the user for user input for the captions and/or tags. These clips or photos can then be arranged into a suitable album to document the child's growth and development. The clips and photos can be organized chronologically, by event (e.g. different birthdays are stored in different albums), by age, or by any other organizational category desired by the user. As noted above, the album or albums organized by the user can include results from measurements of the child's abilities as measured by the system described above.

Regarding the mobile computing device-based activities available to the user and the child, a number of possibilities are open. The activities are, preferably, easily understood by both the user and child, perhaps with some explanation by the user. As well, the activities are, preferably, simple, requiring simple actions by the child.

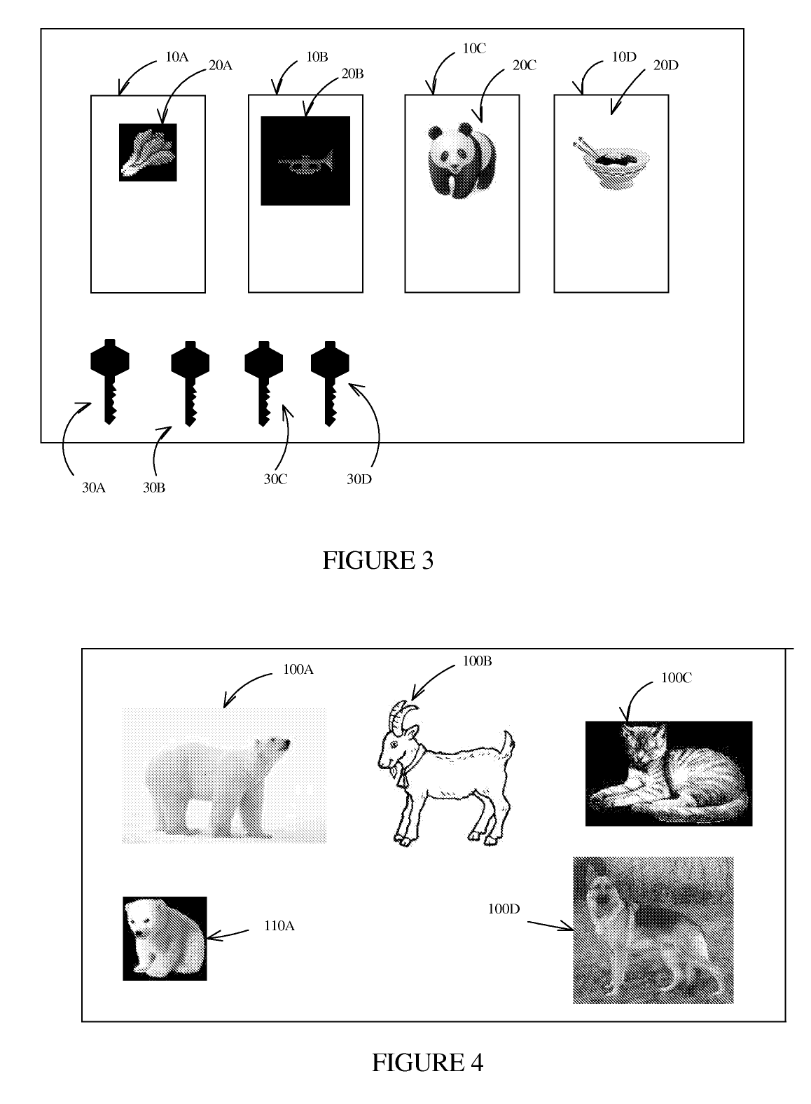

Referring to FIG. 3, a schematic of a screen shot of one environment illustrating the one possible activity is shown. As can be seen, the child user is provided with a number of doors 10A, 10B, 10C, 10D of varying colors and, preferably, with varying icons 20A, 20B, 20C, 20D with each icon representing the activities accessible by activating the specific door. A number of keys 30A 30B 30C 30D are also provided at the bottom of the screen. Each key has a different color and each key color corresponds to a color of one of the doors 10A-10D. The child user can press and drag each of the keys 30A-30D to one of the doors 10A-10D. If the child user drags a key to the door with the same color as the key, this constitutes a desirable input. Each desirable input contributes toward a completion of the activity.

It should be noted that the above activity may be used as a means to access further activities. Once the child makes a proper match between a key and a door, another activity may be launched. The child user may then be granted access to the activities represented by the icon on the door to which the correct key was matched. A vegetable icon 20A would represent a farm area and farming related activities would be accessible. A trumpet icon 20B would represent a music area and music related activities would be accessible. An animal icon 20C would represent a zoo area and zoo or animal related activities would be accessible. A dishes icon 20D would represent a kitchen area and kitchen or food related activities would be accessible.

Referring to FIG. 4, a schematic of a screen shot of a zoo environment illustrating another possible activity is shown. The zoo environment may be accessed by the child user if the key corresponding to the door with the animal icon were dragged to that specific door using the touch screen interface. In one example of a zoo or animal based activity, FIG. 4 illustrates that a number of adult animals 100A 100B 100C 100D are presented to the child user along with a single infant animal 110A at the corner of the screen. If the child user drags the infant animal 110A to the correct adult (or mother) animal 100A, this constitutes a desirable input and contributes towards completion of the activity. If the child user incorrectly drags infant animal 110A to one of the non-matching adult animal 100B 100C 100D, this is an undesirable input and the child is given another chance for an input. To assist the child, each undesirable input may result in the incorrectly matched adult animal being removed from the screen.

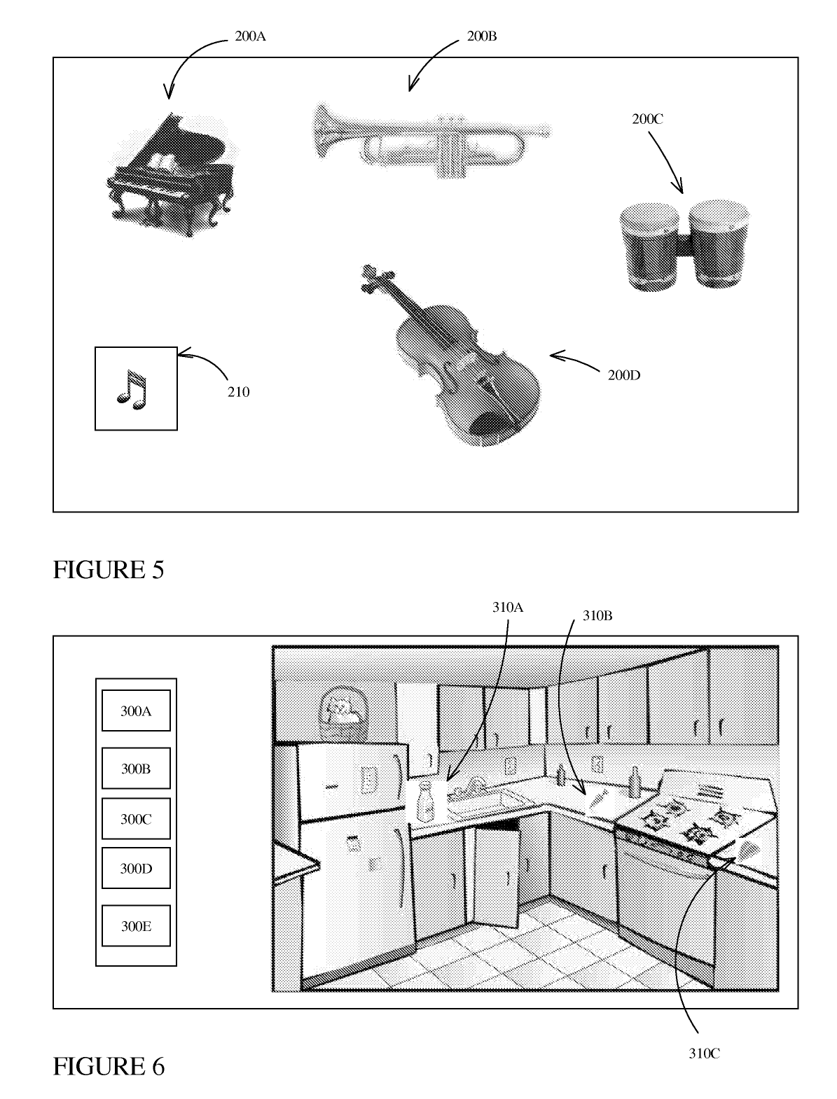

Referring to FIG. 5, a schematic of a screen shot of a music environment illustrating a music related activity is shown. In one implementation, the music environment may be accessed by the child user if the key corresponding to the door with the trumpet icon were dragged to that specific door using the touch screen interface.

As can be seen from FIG. 5, icons 200A, 200B, 200C, 200D illustrate different musical instruments. An activate icon 210 is presented at a bottom corner of the screen. Once the child user activates the activate icon 210, a short tune, which consists of a single instrument being played, is played. The child user then has to either touch the correct musical instrument icon that corresponds to the instrument played. As an example, if the tune is that of a trumpet being played, if the child user activates the trumpet icon 200B this is a desirable input and contributes towards a successful completion of the activity.

Another example of a musical activity, albeit a more advanced one, consists of the child activating a piano icon. This action presents the child user with a single octave keyboard. The child user can play on the keys and hear the sound of the piano. If the child user activates a game activity on the piano, a short musical fragment is played. If the child user plays back the musical fragment (i.e. plays the notes in the correct sequence using the single octave keyboard on the screen), this constitutes as desirable input and can signal an end to the activity.

Referring to FIG. 6, a schematic of a screen shot of a kitchen environment or kitchen area illustrating a kitchen or food based activity is shown. In one implementation, the kitchen environment may be accessed by the child user if the key corresponding to the door with the dishes icon were dragged to that specific door using the touch screen interface. In one implementation, the kitchen environment is represented as being a typical kitchen with cupboards, appliances, and a sink area.

In one activity available in the kitchen area, a number of slots 300A-300E is presented at the bottom of the screen. Various food items 310A-310C are scattered throughout the kitchen environment. The child user can drag any of the food items 310A-310C to the slots 300A-300E. Each nutritionally balanced combination of foods is considered to be a desirable input and contributes to the completion of the activity. Similarly, grouping similar foods together may also constitute a desirable input. In another implementation, if all the slots are filled and a nutritionally balanced combination is not found within the food items in the slots, the slots are emptied and the child user is given another opportunity to fill the slots.

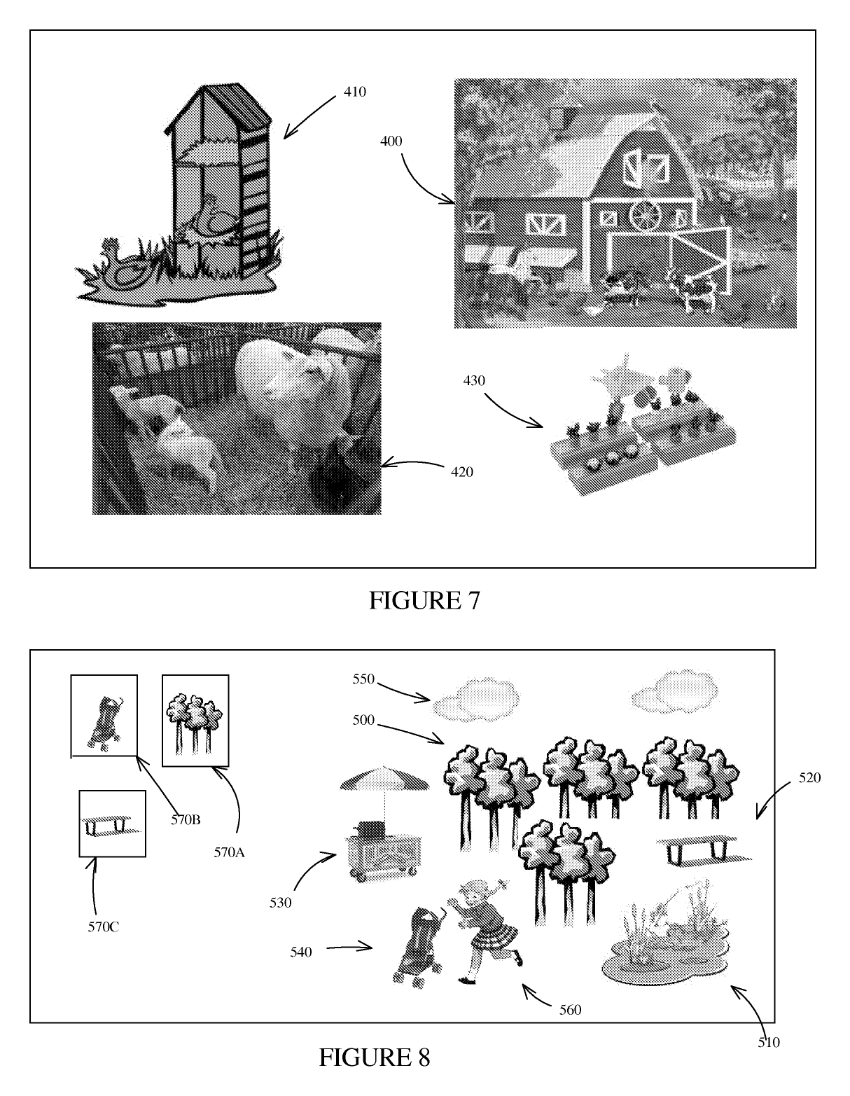

Referring to FIG. 7, a schematic of a screen shot of a farm area or farm environment illustrating yet another activity is shown. In one implementation, the farm environment may be accessed by the child user if the key corresponding to the door with the vegetable patch icon were dragged to that specific door using the touch screen interface. In one implementation, the farm is represented as having a barn area 400, a chicken coop 410 with multiple chickens in nests, a lamb holding pen 420, and a vegetable garden area 430.

When the child user activates any of the areas of the farm environment, a different activity is activated and a new screen may be presented for that activity.

When the barn area is activated, a cow may be illustrated and the child user can, using the touch screen, simulate milking the cow by simply touching the cow. The resulting milk may then be shown as being bottled and/or placed in a truck. When the truck is filled, the activity may terminate. Each bottle filled may contribute towards the completion of the activity.

When the lamb holding pen is activated, a lamb is presented to the child user. By touching the lamb, the child user activates a simulation of the lamb being sheared of its wool. An animation of the lamb being sheared can then be presented to the child user. Once all the wool has been sheared, the activity may terminate.

For the vegetable garden area, when the child user activates this area, a vegetable garden is presented to the child user. The child user can then pick the vegetables in the garden and place them in a basket in a corner of the screen. The vegetables are originally shown as sprouting from the ground with only their tops showing. When the child user activates each vegetable top by touching its location on the screen, a full representation of the appropriate vegetable is presented and this can be dragged to the basket at the side of the screen. Each vegetable “picked” from the garden contributes to the completion of the activity. Once the basket is full, another animation—this time that of filling a stall in a market with the vegetables in the basket—may be presented to the child user. A full basket can be used to signal an end to the activity.

For the chicken coop area, activating the icon presents the child user with a number of chickens on their nests. The child user can activate each chicken by touching the screen where the chicken is located. This activates an animation which would show whether there is an egg underneath the chicken. Each egg discovered results in a desirable input and contributes towards completion of the activity. Each egg can then be shown as being placed in an egg container. A full container can be shown when the activity terminates.

Another possible environment similar to the above environments would be that of a park environment or park area. FIG. 8 illustrates such an area where the child user can access other activities. The park environment would have a multitude of icons representing objects normally seen in or from a park. Trees 500, a pond 510, bench 520, hotdog cart 530, stroller 540, clouds 550, and people 560 are illustrated. One possible activity for this environment would involve flash cards 570A-570C which illustrate things found on the screen for the environment. The items or things illustrated on the flash cards 570A-570C would then need to be matched to the matching card. As an example, the child user can drag flash card 570A illustrating a tree to the tree 500. Each correct matching between an item and a card constitutes a desirable input and contributes towards completion of the activity. If, on the other hand, the child user incorrectly matches a card with an object (e.g. flash card 570B illustrating a person is dragged to the stroller 540), this is an undesirable input the child user is given another chance for input. After a match is made, the matching card may be replaced by another, random card.

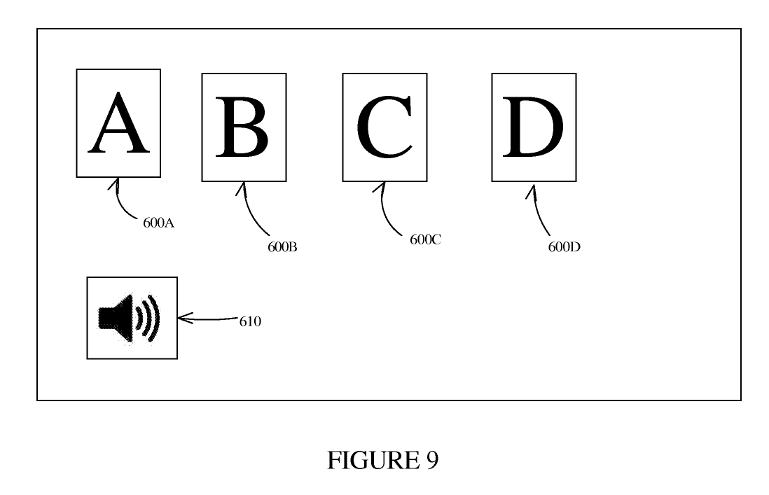

Referring to FIG. 9, another activity which the child user may activate involves the recognition of letters and their sounds. As shown in FIG. 9, a number of icons 600A-600E are presented to the child user with an activate or Play button 610 at the corner of the screen. Once the activate button has been pressed (using the touch screen interface), a recording of a letter being spoken is played. The child user then has to press the appropriate letter on the screen. A correct answer will contribute towards completion of the activity, the activity being terminated after a certain number of letters have been identified. Of course, the letters in FIG. 9 and the activity as a whole may involve, instead of letters, number or other educational indicia.

Because the child user may range in age from a few months old to up to 4 years old, a phased approach to education/entertainment may be used in conjunction with the various activities described above. As an example, less onerous activities or activities which require more developed cognitive abilities or more developed observational skills may be provided later in an application with the simpler activities being provided to the younger of the users. The activities which require color matching may be reserved for older child users as the very young child users may not be able to distinguish between the various colors. As well, activities which would require better spatial sense or a more developed ability to distinguish different sounds or images would be reserved for the older child users.

In one implementation, a software application having the various activities described above would have a phased approach in that the activities are nested so younger child users can only access the simplest of activities. As the child user grows older and develops more cognitive abilities (and can, hence, participate in and complete more of the activities) more complicated and complex activities become available to that user. As an example, activities involving music fragments and/or identifying musical instruments may be inaccessible to six month old child users but may be fully accessible to 3 or 4 year old child users. Alternatively, instead of having the application automatically restrict the activities available to the child user, the user (an adult) may determine which activities are to be made available to the child user.

The phased approach noted above preferably does not just apply to the activities provided to the child user. The color palette used in presenting the activities, the rewards, and indeed the whole look and feel of the user interface preferably also takes into account the cognitive abilities of the child user. The software application can be told (by an adult user assisting the child user) the age (in months and/or years) of the child user and the application can adjust its color palette so that the various icons and indicia are actually distinguishable by the child user. As an example, for child users who are less than a year old, pastel colors may be removed from the color palette used by the application as such young child users are unable to distinguish between the different pastel colors. Of course, for child users older than one or two years old, the pastel colors are placed back in the color palette automatically.

It should be noted that, once the assessment data has been gathered for the child, the user may be prompted as to whether he or she would be willing to share the data with a database for similarly aged children. Of course, the data would be anonymized to protect the privacy and identities of those involved and data would not be shared unless the user/parent agrees to it. The resulting database from the users sharing their data would be useful for researchers and other parents as they would represent child developmental data from real-world children and not simply those who have developmental problems. As well, the resulting database would give an indication of the development of children in specific socio-economic backgrounds as opposed to data gathered for children in general.

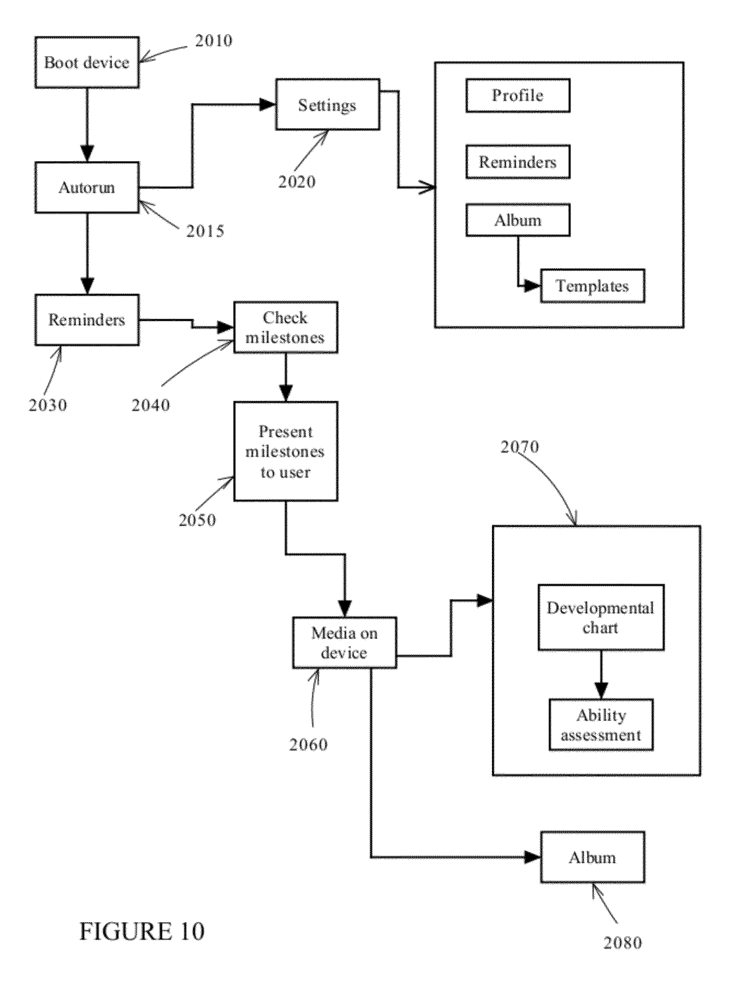

Referring to FIG. 10, a flowchart according to one aspect of the invention is illustrated. The process is the software logic flow as implemented for mobile computing devices. The process begins with step 2010 as the device is booted up. Once up and running, the autorun functionality of the device (2015) then either brings the user to the settings section (step 2020) or to a reminders section (step 2030). The autorun functionality brings the user to the setting section if the device has not yet been configured. The reminders section provides the user with reminders previously programmed into the device.

In the settings section, the user can configure his or her profile (name, registration for the device and the software, prompt for the child's age or birthdate, etc.), any reminders he or she may wish (e.g. monthly reminder to test a child's abilities, monthly reminder to take the child's photo or video, a quarterly reminder to take a video clip of the child, etc.), as well as configure the album for the child. The reminders can be of a weekly, monthly, quarterly, or yearly character. The reminder system can be used to remind the user to take period assessments of the child's abilities, to remind the user to take periodic pictures of videos of the child, or to remind the user of other important periodic events for the child such as visits to the paediatrician. The album (which can be preconfigured so that it looks and reads like a story book) can be configured depending on the child's gender and/or on the user's visual presentation preference. As an example, preconfigured templates for a male child or a female child may be made available to the user. Alternatively, a classic album template (e.g. with wooden looking borders or backgrounds) may be used. As well, a so-called contemporary template, with a more modern look, may be used.

Once the reminder section (step 2030) is accessed, the system can then check the previously programmed milestones (step 2040). These milestones can be from a short list (the user ranked most important milestones) or a complete list of all user programmed milestones. More possible milestones can be configured as being anchored to the child's birthdate. Based on the birthdate, milestones such as quarterly photo reminders, birthdays, the passing of a specific birthday for the child (e.g. 3^{rd} birthday), and others can be generated. Of course, the user can configure other milestones not specifically programmed for in the software.

After checking the milestones, the relevant milestones are then presented to the user (step 2050). The user is then directed to the media files stored on the device (step 2060). From here, the user can select from a number of options. The user can view a developmental chart and, along with the developmental chart, view a listing of activities for the child so that the child's abilities can be assessed (step 2070). Alternatively, the user can view the album with the digital photos, videos, and assessments currently stored in the album (step 2080).

It should be noted that the software mentioned above stores data in a database on the mobile computing device. In addition to the other data the software may need, the milestones, the age norms (developmental charts), the templates for the album, and any media files it may require are all stored on the database on the device.

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-Roms, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language For example, preferred embodiments may be implemented in a procedural programming language (e.g. “C”) or an object oriented language (e.g. “C++”, “java”, or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

Having thus described the invention, what is claimed as new and secured by Letters Patent is:

1. A method for tracking and documenting a child's developmental progress, the method comprising:
a) determining said child's age;
b) providing a user with expected capabilities for a similar child of similar age;
c) providing said user with a plurality of activities for said child, said activities being for assessing said child's abilities;
wherein said method is executed on a mobile computing device.

2. A method according to claim 1 wherein step a) comprises prompting said user to enter said child's age into said mobile computing device.

3. A method according to claim 1 wherein step b) comprises providing said user with a chart detailing expected capabilities for children of different ages.

4. A method according to claim 1 wherein step b) comprises providing said user with a detailed description of expected capabilities for said similar child having a similar age.

5. A method according to claim 1 wherein said activities comprise at least one game in which said child identifies specific icons from a collection of icons.

6. A method according to claim 1 wherein said activities comprise at least one game in which said child matches one on-screen indicia with another on-screen indicia.

7. A method according to claim 1 wherein at least one of said activities is music-based.

8. A method according to claim 1 wherein at least one of said activities is language based.

9. A method according to claim 1 wherein at least one of said activities is math based.

10. A method according to claim 1 wherein said method further comprises the step of providing said user with an option to record digital images of said child.

11. A method according to claim 10 further including the step of organizing digital images of said child into albums.

12. A method according to claim 11 wherein said albums include results from assessments of said child's abilities.

13. A method according to claim 1 wherein said child's abilities are assessed by timing said activities.

14. A method according to claim 1 wherein said child's abilities are assessed by determining a number of attempts before completion of at least a portion of one of said activities

15. A method according to claim 1 wherein step c) further comprises providing said user with instructions for at least one physical activity for said child.

16. A method according to claim 15 wherein step c) further comprises providing said user with instructions for assessing said child's abilities using said at least one physical activity.

17. Computer readable media having encoded thereon computer readable instructions which, when executed, executes a method for tracking and documenting a child's developmental progress, the method comprising:
a) determining said child's age;
b) providing a user with expected capabilities for a similar child of similar age;
c) providing said user with a plurality of activities for said child, said activities being for assessing said child's abilities;
wherein said method is executed on a mobile computing device.
